(19) United States
(12) Patent Application Publication
(10) Pub. No.: US 2008/0312786 A1
(43) Pub. Date: Dec. 18, 2008

(54) WIRELESS ON-BOARD DIAGNOSTICS FOR HEAVY DUTY TRUCKS

(75) Inventor: Jeffrey Lee Day, Lexington, NC (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/763,100

(22) Filed: Jun. 14, 2007

(51) Int. Cl. G06F 7/00

(52) U.S. Cl. 701/33

(57) ABSTRACT

A device, system, and method are provided that can request and report on-board diagnostics (OBD) data wirelessly thereby allowing a vehicle to provide its OBD test data in real-time without being taken out of service. This capability can provide significant advantages for fleets in minimizing the impact of OBD testing requirements on vehicle downtime.

### BACKGROUND

In recent years, sophisticated electronic subsystems have been, used in the heavy-duty vehicle industry, particularly with tractor-trailer combinations involving data transmission. State emissions testing is usually applied on the basis of a manufacturer's weight rating for a vehicle, e.g. light heavy duty, medium heavy duty and heavy duty. Diesel engines used in heavy-duty vehicles are divided into service classes according to gross vehicle weight ratings (GVWRs). Federal law (40 CFR 86.094 et seq.) defines the various categories of heavy-duty vehicle service classes according to GVWRs of above 8,500 lbs. A light heavy-duty diesel engine designation applies to an engine used in a vehicle having a GVWR of between 8,500 lbs. and 19,500 lbs. A medium heavy-duty diesel engine designation applies to an engine used in a vehicle having a GVWR of between greater than or equal to 19,500 lbs. and less than or equal to 33,000 lbs. A heavy-duty diesel engine designation applies to an engine used in a vehicle having a GVWR of greater than 33,000 lbs. Basic emission standards are expressed in g/bhp·hr (“g/bhp-hr” means grams/brake horsepower-hour) and require emission testing over the Heavy-Duty Federal Test Procedure (FTP) Transient Cycle, although some heavy-duty gasoline vehicles have pertinent emission standards expressed in grams/mile (g/mile).

Emissions tests are usually required annually with a vehicle registration. Typically, vehicles, such as light duty diesel-powered vehicles undergo emissions testing using dynamomenter measurements. A dynamometer places a load on an engine and measures its performance. In some jurisdictions, trucks within the heavy duty diesel class are not required to undergo annual emissions inspection and must simply adhere to opacity standards few visible smoke. Such tests usually require that a vehicle be taken out of service, whether through measurements taken at a State emissions facility or for exhaust opacity measurements at a weigh station or through an on-the-road enforcement program using specially equipped emissions testing vehicles.

Portable emission measurement systems (PEMS) have been under development for some time. The United States of America as represented by the Adminstrator of the U.S. Environmental Protection Agency (EPA) has been assigned U.S. Pat. Nos. 6,148,656 and 6,382,014 awarded to Leo Breton entitled “Real-Time On-Road Vehicle Exhaust Gas Modular Flowmeter and Emissions Reporting System”, better known as ROVER. ROVER is a PEMS device that provides a method for measuring mass flow from engines. Mass flow measurement in turn provides a method for measuring emissions.

Today's vehicles have, an on-board electronic control unit (“ECU”) and include electronic subsystems such as vehicle security, engine operations, and monitoring, etc. PEMS may also be added. There are several methods for providing data communications within vehicles. Communication systems compliant with the Society of Automotive Engineering (SAE) standard J1708 and the more recent SAE standard J1939 are generally used for data communications in the heavy-duty vehicle environment. In 2007 and 2010, a series of on-board diagnostic (OBD) regulations are slated to go into effect for heavy duty trucks. These standards are similar in nature to the OBD requirements applied to passenger cars in 1996 and following. Many states require cars to pass an OBD test every year. Such a requirement will be applied to heavy duty trucks as well. This will require taking the track out of service, and taking it to an OBD testing center resulting in downtime for each truck. Many of the OBD tests are run on the vehicle in a continuous manner, and the test station simply queries the ECM for the latest test results. Other tests are run in an on-demand manner.

Along with concern over vehicle emissions control, there is a need to maximize truck time-in-service. Taking a vehicle such as a truck out of service for emissions testing and/or reporting causes considerable down-time. Consequently, a need exists to maximize vehicle usage in connection with complying with regulations requiring vehicle testing, such as emissions testing.

### BRIEF DESCRIPTION OF THE DRAWINGS

Some of the features and advantages of the present invention have been stated, others will become apparent as the description proceeds when taken in conjunction with me accompanying drawings, in which;

FIG. 1 is a diagram of a vehicle in the form of a heavy duty vehicle, namely, a tractor and trailer combination, linked with remote locations using data communication system.

FIG. 2 is a block diagram showing a data communication apparatus used to provide data communications wirelessly between a tractor-trailer combination and a remotely located data communications terminal or facility.

FIG. 3 illustrates a block diagram of a vehicle communication embedded processor preferably including a message encapsulation device, and a buffer in communication with the message encapsulation device.

FIG. 4, is a flow diagram of a method for providing data communications between a vehicle, such as the tractor-trailer combination, and a remote data communications terminal, facility, monitoring device, etc.

Applicable reference numerals have been carried forward.

### DETAILED DESCRIPTION

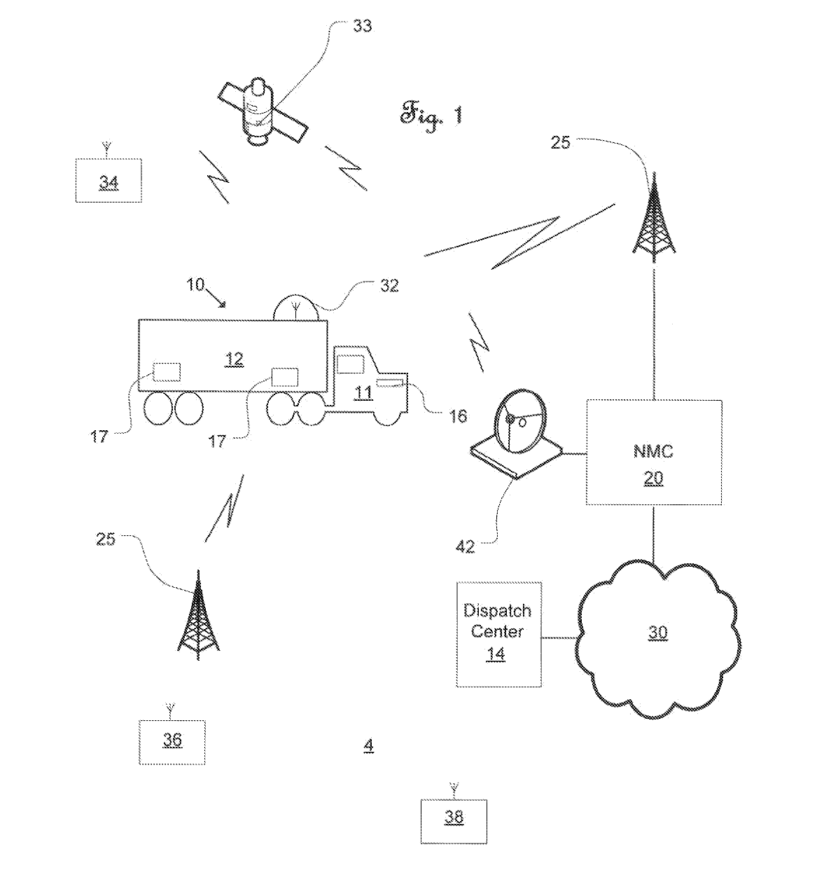

FIG. 1 is a diagram of a vehicle in the form of a heavy duty vehicle, namely, a tractor and trailer combination, linked with remote locations using data communication system 4. As shown, a heavy-duty vehicle such as a tractor-trailer combination 10 may include tractor 11 and trailer 12. Each of tractor 11 and trailer 12 preferably include respective frames and couplers for mechanically coupling to each other. An engine (not shown), such as a diesel engine, is provided within tractor 11 for moving tractor 11 and thereby pulling trailer 12.

Tractor-trailer combination 10 also preferably includes various electronic subsystems 16. For example, tractor 11 may include electronic subsystems such as an anti-locking brake system (“ABS”), a data communication system, a fuel monitoring system, and an engine power monitoring system. Trailer 12 may include electronic subsystems 17 such as a weight detection system, a trailer power monitoring system, a refrigeration system, an ABS, and a backup data communication system, such as understood by those skilled in the art. Other examples of these electronic subsystems 17 and features which may be monitored and/or controlled by the apparatus disclosed herein are illustrated, but not limited to the following for a tractor/trailer combination in Table I below;

TABLE 1
Tractor/trailer Functions

| | |
|---|---|
| Emissions | Engine Component Failure |
| Active Tire Pressure | Lamp Outage Monitor |
| Anti-lock Brake Failure | Engine Operations and Diagnostics |
| Backup Alarm | Fuel Status |
| Backup Lamps | Trailer Weight Detection |

Electronic subsystems 17 may be connected to each other via electrical conductors (not shown) such as twisted pair wire or other wiring standards or schemes. Electronic subsystems 16, for example, can be accessed through a connector such as a six-pin Deutch connector, a 7-pin connector or other well-known connectors (not shown) used within tractor or trailer environments. Also, tractor 11 provides a convenient location for a driver or any authorized person to inspect the operational conditions of the tractor-trailer combination 10,

FIG. 1 further illustrates data, communication system 4 including network management computer or controller (NMC) 20 coupled, to a plurality of receivers, e.g., mobile communications terminals (MCT) 32, 34, 36 and 38 via a wireless network. MCT 32, 34, 36 and 38 may be representative of communication systems held by other vehicles. A network management facility (NMF) (not shown) acts as a central communication station through which all communications between vehicles and a dispatch center 14 pass. The NMF includes a number of network computers (NMCs), each NMC 20 being responsible for providing a communication path for the NMF (not shown) to geographically dispersed vehicles and/or equipment in the communication system using a geo-stationary satellite 33 or other wireless system. A geostationary satellite includes one or more transponders. Transponders relay up and down link signals, (providing amplification and frequency translation) between geographically-dispersed earth stations which may be fixed or in-motion. Each NMC 20 is assigned with different up and down link frequencies in order to avoid interference involving other MCTs that are operating on the same satellite but with a different NMC. In the satellite communication system, each NMC is capable of handling the communication needs of approximately 30,000 vehicles.

It should be understood that the term “receiver” is used throughout to denote any device remotely located from NMC 20 which is capable of receiving data from NMC 20. As such, the term receiver encompasses both wireless and wireline devices. In addition, the receiver typically includes a transmitter for transmitting data to NMC 20.

NMC 20 is coupled to one or more dispatch stations 14 via Internet connection, dialup connection or direct connection (e.g., local, area network) 30. Communication system 4 may be used to track and communicate with vehicles in a fleet. Each MCT is mounted in a vehicle or is part of a mobile device optimally geographically located within the operational boundaries of wireless network 4. Dispatch station 14 may receive and/or transmit data between each MCT 32, 34, 36 and 38 via NMC 20 and wireless network 4. The data communicated therebetween may include digital information transmitted in packet format and such communications may occur as a consequence of being polled from NMC 20 or they may be event driven. Further, such communications may be message based without requiring data streaming.

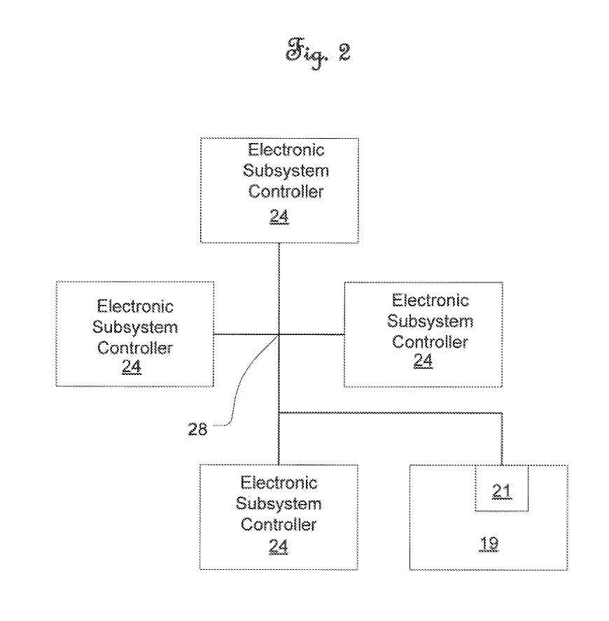

FIG. 2 is a block diagram showing data communication apparatus 19 used to provide data communications wirelessly between the tractor-trailer combination 10 (shown in FIG. 1) and a remotely located data communications terminal or facility such as NMC (FIG. 1), in accordance with one contemplated embodiment. As shown, the data communication apparatus 19 preferably has a processor such as vehicle data communication embedded processor 21. The vehicle communication embedded processor 21 is preferably connected to, or in communication with, the tractor-trailer combination 10 of FIG 1.

Embedded processor 21 is preferably connected through electrical conductors 28 to electronic subsystem controllers 24. Each controller 24 preferably includes a microprocessor operating according to stored programs designed to perform various functions related to monitoring and/or controlling electronic subsystems within the tractor-trailer combination 10 of FIG 1. In one aspect, electronic subsystem controllers 24 may advantageously communicate with each other through various types of communication technology, including J1939, J1587, power line carrier (“PLC”) technology, infrared technology, radio frequency technology, and other communications technologies as well understood by those skilled in the art. Additionally, each electronic subsystem controller 24 may preferably include a signal generator (not shown) for generating a signal related to the operation of a vehicle such as the tractor-trailer combination 10. For example, each controller 24 may generate a number of output control signals in the form of relay contact closures or other signals to one of the electronic subsystems. Data communication apparatus 19, via Embedded Communication Processor 21 is connected to each electronic subsystem controller 24 allowing vehicle electronic subsystems such as emissions control and/or monitoring to report real time emissions data to a remote location. Further, in another aspect, subsystems may be controlled remotely from a remote data, communications terminal (not shown) through data communication apparatus 19. Date communication apparatus 19 may be used to provide wireless communications such as between the tractor-trailer combination 10 traveling on the road and a data communications terminal or system located at a remote location away from the vehicle. The remote location, for example, may be a State-run emissions control center, a weigh station, a fuel distribution station, an office building, a dispatch center, a fleet management center, a vehicle (especially a vehicle having emissions monitoring equipment), etc.

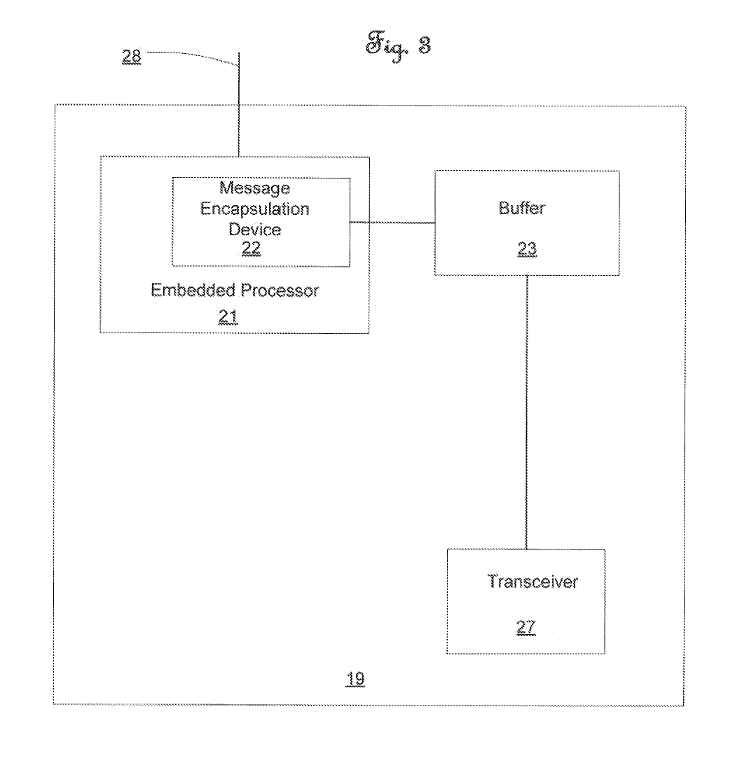

FIG. 3 illustrates a block diagram of vehicle communication embedded processor 21 preferably including message encapsulation device 22, and buffer 23 in communication with message encapsulation device 22. Connected to the electrical conductors 28 (e.g., twisted pair), message encapsulation device 22 encapsulates data of a first data communication protocol used by data communications along the electrical conductors 28 for storage in buffer 23. The first data communication protocol is preferably a data communication protocol conventionally associated with a vehicle environment, such as the standard promulgated by the Society of Automotive Engineering (SAE), including, but not limited to SAE J1939 which supports communications associated with the engine (“black box”) Electronic Control Unit (ECU), which provides control of exhaust gas emissions within US and European standards. SAE J1939 has been adopted widely by diesel engine manufacturers. One driving force behind this is the increasing adoption of the engine. SAE J1939 can now be found in a range of diesel-powered applications: vehicles (on- and off-road), marine propulsion, power generation and industrial pumping.

A second wireless data communication protocol is used to provide communications between a vehicle and a location remote from the vehicle. As such, the second data communication protocol, for example, may be a radio frequency (RF) data communication protocol, an infrared (IR) data communication protocol, a satellite data communication protocol, or a microwave or other high frequency data communication protocol. For instance, communications may occur with satellite 33 (shown in FIG. 1) which may represent a low orbiting satellite or a geostationary or geosynchronous satellite as a means to convey information such as vehicle emissions data. Further, data may be provided within a communications system involving a terrestrial uplink from satellite center 42 (shown in FIG. 1). Other over-the-air data communication protocols may be used as well as understood by those skilled in the art. The RF data communication protocol for example, may be a simple modulation scheme or a complex protocol. For example, the RF data communication protocol can be a wireless transmission, protocol according to the IEEE 802.11b (Wi-Fi) standard. Other RF data communication protocols, for example, that may be used herein include Bluetooth, 900 Megahertz, and other RF data communication protocols as understood by those skilled in the art. Further, mobile communications may be employed using, for instance, code division multiple access (CDMA), time division multiple access (TDMA), frequency division multiple access (FDMA), Universal Mobile Telecommunications System (UTMS) and WiFi to transfer data, including emissions data from, for instance, a heavy truck to a vehicle having emissions monitoring equipment pursuant to an on-the-road enforcement program. The monitoring and transfer of data may occur without having to pull, a vehicle from service while testing. Therefore, it is contemplated where random emissions testing is performed by specially equipped vehicles, that the foregoing will allow testing and transfer of data from a vehicle without the vehicle having to stop. A vehicle with wireless communications capability need only pull alongside or within range of a truck and download emissions data. Whereas state vehicles used to perform on-the-road tests were requited to have special measuring equipment, the disclosure herein now permits testing vehicles to be equipped merely with data communications equipment (sans test equipment) able to receive data transfer from a vehicle which performs its own tests and sends its own data. Some level of security or monitoring may be provided for the testing equipment so as to prevent tampering and thereby false readings.

In the illustrated embodiment shown in FIG. 3, message encapsulation device 22 may include one or more microprocessors and/or microcontrollers coupled to a transceiver 27 that transmits and receives logic level signals, and an RF or, Wi-Fi (e.g., or 802.11 compliant) integrated circuit. The RF compliant integrated circuit may include a microprocessor or microcontroller, but may also be a separate device. Transceiver 27 is preferably a physical layer signal communications transceiver which has a transmitting portion and a receiving portion. Message encapsulation device 22 packages data according to the first data communication protocol for wireless transmission via the second data communication protocol. Consequently, data according to the first data communication protocol is encapsulated and dispatched to a location remote from the vehicle using second data wireless communication protocol. Thereafter, receivers and possible relayers or transmitters of the information along the path toward an ultimate destination, need not have knowledge of the first data communication protocol. Once the data arrives at its ultimate destination, it may be de-encapsulated and read. Preferably, data communication apparatus 19 may provide an option to transmit using an over-fee air-protocol selected from a multiple of choices, such as communication using TDMA, CDMA, FDMA,GSM, UTMS, satellite, Wi-Fi, Bluetooth, etc, depending upon what's available in the mobile communications environment per the particular geography. This methodology is particularly well suited for mobile communications wherein a communication link with a remote station cannot be achieved using one or more communication over-the-air protocols. Encapsulation allows successful communications involving virtually any type of second wireless data communication protocol for over-the-air transmission.

At the NMC, dispatch station, State Emissions Control Center, etc., data is provided to message de-encapsulation device (not shown) which de-encapsulates the received message. The received message may be provided to a monitoring device, facility or computer (not shown).

With reference to FIG. 1, emissions data may be transferred from the vehicle in connection with a poll of vehicles takes by NMC 20 as directed by dispatch center 14. For instance, a fleet owner may request, through dispatch center 14, that fleet vehicles (e.g., tractor-trailer 10) be polled for emissions data and/or emissions/engine problems. NMC 20 may take care of the request resulting in fleet vehicles forwarding the requested information. With reference to FIG. 2, alternatively, upon expiration of a specified period of time, a timer within vehicle, communication embedded processor 21 may cause data communication apparatus 19 to broadcast emissions data for receipt by a State Emissions Control facility or transmit emissions data to NMC 20. Where transmission of emissions data is sent to other than NMC 20, it is contemplated that the State Emissions Control facility receive the emissions data via Internet connection, satellite, dialup connection, or direct connection (e.g., local area network) 34 from the entity receiving the emissions data from the vehicle. In one aspect, the broadcast of emissions data may occur in conjunction with vehicle position detection, whether remote server based or position detection at the vehicle. Further, such position determination may occur using the Global Positioning System (GPS). For instance, in connection of the vehicle being in the proximity of a State Emissions Control facility, vehicle emissions data may he transmitted (or broadcast) to the facility (assuming the State Emissions Control facility has the appropriate receiving capability). Assuming that some aspect of the disclosure herein is incorporated into a standardized emissions control collection procedure, it is contemplated that the State Emissions Control facilities will possess the appropriate communications equipment to receive (and respond to) the wireless (and wireline) transmission of data. Alternatively, in connection with emissions data being transmitted to a remote location, the emissions data may be forwarded to a State Emissions Control facility via Internet connection, dialup connection or direct connection (e.g., local area network). Further, in connection with the transmission or broadcast of emissions data to one or more remote locations, a confirmation may be sent to the vehicle indicating receipt of the emissions data. Additionally, events such as engine or valve failure or malfunction within an engine may serve as events for which data communication apparatus 19 transmits data indicative of such failure to the remote location (e.g., NMC, dispatch center, fleet owner, etc).

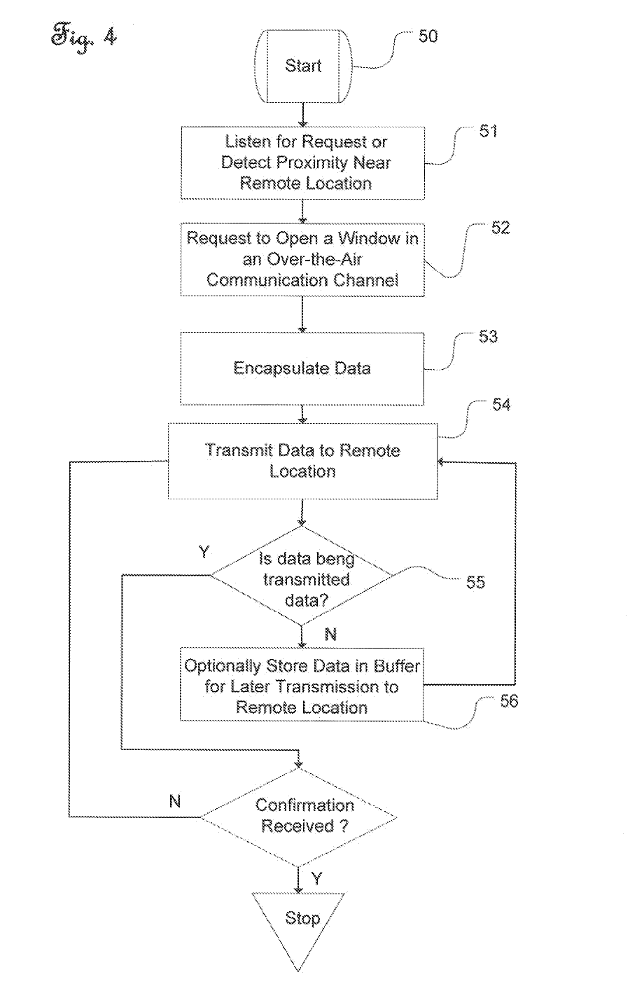

FIG. 4 is a flow diagram of a method for providing data communications between a vehicle, such as the tractor-trailer combination 10, and a remote data communications terminal, facility, monitoring device, etc. Starting at block 50, the vehicle (or the remote terminal) preferably is “listening” for a data request from the remote data communications terminal or is waiting for detection of the vehicle in the vicinity of the remote location (e.g. State Emissions Control facility) as shown in block 51. After a data request has been received, the vehicle then requests to open a window in an over-the-air communication channel between the vehicle and die remote data communications terminal, as depicted in block 52. Such request is made through a requestor that can be implemented via software or hardware at each of the vehicle and the remote data communication terminal. In the present example, the requestor is preferably implemented in software capable of opening a window is an over-the-air communication channel.

Next, data of a local-area vehicle communication protocol (i.e., SAE J1939) is encapsulated within data of an over-the-air communication protocol (i.e., RF data communication protocol), as shown in block 53. As shown in block 54, the data of the over-the-air communication protocol is then wirelessly transmitted from a transceiver within the vehicle to a transceiver remotely located from the vehicle assuming that a window in an over-the-air communication channel between the vehicle and the remote data communications terminal is available. In connection with a determination whether data is being transmitted (block 55), wherein no such window is provided, the data stored in the buffer remains there until a current data transmission has been completed. If the remote data communications terminal is not transmitting data, the data stored in the buffer can be extracted from or transferred from the buffer for transmission as shown in block 54. The electronic subsystems of the vehicle may then be directly observed, monitored, disposed, or impacted by interaction with the remote terminal, e.g. the NMC. In one optional aspect, a confirmation may be received from a remote location verifying its receipt of emissions data sent wherein further attempts are made to transmit the data should no confirmation be received. Further, emissions data may be reported without pulling the vehicle out of service.

As illustrated in FIG. 4, the foregoing also advantageously provides methods for enhanced data communications between a vehicle and a remote data communications terminal. A method preferably includes requesting an opening of a window in an over-the-air communication channel between a vehicle and a remote data communication terminal (assuming for instance that some form of communications with the remote data communication terminal and the vehicle are ongoing); wirelessly transmitting data using an over-the-air communication protocol from the vehicle to the remote data communication; and optionally receiving instructions or data which may be calculated to control selected functions of the vehicle.

As has been described, the present Invention provides an apparatus and method for providing data communications between a vehicle and a remote data communications terminal. It is understood by those skilled in the art that the foregoing may be utilized by any type of vehicle, including passenger vehicles such as automobiles, sedans, sports utility vehicles, trucks, boats, military vehicles, and is particularly advantageous with heavy-duty vehicles such as tractor and/or trailer combinations, recreational vehicles, agricultural tractors, transportation vehicles, etc.

It is also important to note that although the present invention has been described in the context of a fully functional data communications system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

The above description and drawings are only illustrative of preferred embodiments that achieve the objects, features and advantages of the present invention, and it is not intended that the present invention be limited thereto. Any modification of the present invention that comes within the spirit and scope of the following claims is considered to be part of the present invention. Although the invention herein has been described with reference to particular embodiments, it is to be understood that these embodiments are merely illustrative of the principles and applications of the present invention. Although the terra State Emissions Control facility has been used throughout it is contemplate that this term apply to any emissions control facility whether state owned or not or whether such a term be more appropriately applied to a facility owned or operated by some other government entity, e.g. province. It is therefore to be understood that numerous modifications may be made to the illustrative embodiments and that other arrangements may he devised without departing from the spirit and scope of the present invention as defined by the appended claims.

What is claimed is:

1. A method of reporting emissions data comprising:
collecting emissions information from one or more electronic devices on a vehicle; and
wirelessly transmitting said emissions data to a remote location.

2. A method as recited in claim 1 wherein said remote location is selected from the group consisting of a dispatch station, an emissions control center, or another vehicle.

3. A method as recited in claim 1 wherein wireless transmitting emissions data occurs in response to a request for emissions data.

4. A method as recited in claim 1 wherein said emissions data is provided according to a first communications protocol and encapsulated prior to wirelessly transmitting said emissions data to a remote location, according to a second communications protocol.

5. A method as recited in claim 1 wherein said second communications protocol consists of a protocol using, CDMA, TDMA, FDMA, GSM, Bluetooth, 900 Megahertz, 800 Megahertz, Wi-Fi, or satellite.

6. A method as recited in claim 1 further comprising:
retransmitting said emissions data pending confirmation of receipt from said remote location.

7. A method as recited in claim 1 wherein said collecting emissions information and transmitting said emissions information occurs in connection with said vehicle moving.

8. A method as recited in claim 1 wherein emissions data is provided to an emissions control center via a method of communicating using one consisting of an Internet connection, a dialup connection or a direct connection.

9. A device for providing emission data wirelessly from a vehicle to a remote location comprising:
a data encapsulation device operable to encapsulate data according to a first communication protocol for transmission according to a second communication protocol; and
a transceiver coupled to said data encapsulation device being operable to transmit vehicle emissions data and receive requests for vehicle emissions data.

10. A device as recited in claim 9 wherein said first communication protocol consists of a protocol selected from SAE J1939 or SAE J1587.

11. A device as recited in claim 9 wherein said second communication protocol is selected from the group consisting of a protocol using satellite communications, WiPi, Bluetooth, 900 MHz, 800 MHz, CDMA, TDMA, FDMA or GSM.

12. A device as recited in claim 9 which further includes a buffer for storing emissions data.

13. A device as recited in claim 9 further including an apparatus capable of selecting from a multiple choice of second communication protocols by which said transceiver transmits said emissions data.

14. A system for providing vehicle emissions data to a remote location comprising:
a portable emission measurement system;
a data encapsulation device operable to encapsulate data, received from said portable emission measurement system, according to a first communication protocol for transmission according to a second communication protocol;
a transceiver coupled to said data encapsulation device being operable to transmit vehicle emissions data and receive requests for vehicle emissions data.

15. A system as recited in claim 14 wherein said first communication protocol consists of a protocol selected from SAE J1939 or SAE J1587.

16. A system as recited in claim 14 wherein said second communication protocol is selected from the group consisting of a protocol using satellite communications, WiPi, Bluetooth, 900 MHz, 800 MHz, CDMA, TDMA, FDMA or GSM.

17. A system as recited in claim 14 which further includes a buffer for storing emissions data.

18. A system as recited in claim 14 wherein said portable emissions measurement system measures vehicle engine mass flow.
